(19) United States
(12) Patent Application Publication
(10) Pub. No.: US 2026/0035012 A1
(43) Pub. Date: Feb. 5, 2026

(54) Method for Performing a Highly Automated Driving Operation of a Vehicle

(71) Applicant: Robert Bosch GmbH, Stuttgart (DE)

(72) Inventors: Keisuke Namura, Yokohama City (JP); Stefan Werder, Hannover (DE)

(21) Appl. No.: 19/288,782

(22) Filed: Aug. 1, 2025

(30) Foreign Application Priority Data
Aug. 5, 2024 (DE) 10 2024 207 401.2

(51) Int. Cl. B60W 60/00

(52) U.S. Cl. CPC B60W 60/001; B60W 2520/06; B60W 2520/10; B60W 2520/105; B60W 2540/30; B60W 2552/00; B60W 2555/20; B60W 2556/10

(57) ABSTRACT

A method for performing a highly automated driving operation of a vehicle includes A) reading driving behavior recommendation data into the vehicle for at least one route sequence on which the vehicle is planned to travel, and B) performing a highly automated driving operation of the vehicle based on the driving behavior recommendation data read according to step A).

This application claims priority under 35 U.S.C. § 119 to application no. DE 10 2024 207 401.2, filed on Aug. 5, 2024 in Germany, the disclosure of which is incorporated herein by reference in its entirety.

### BACKGROUND

Systems for highly automated and/or even autonomous driving operation require special data that enable the planning of highly automated and/or even autonomous driving operation. Such data is usually referred to as map data. Unlike map data used, for example, in a conventional navigation system in a vehicle, which only describes the course of roads, map data for highly automated and, in some cases, even autonomous driving functions contains considerably more detailed information. Such map data may, for example, contain a precise digital description of the environment of a road or lane. In special versions, however, such map data may also contain specific recommendations, e.g., how a vehicle should drive on a particular road in order to participate in traffic in an advantageous manner.

Such map data is usually obtained using a wide variety of approaches. For example, there are crowd-based approaches in which a plurality of vehicles are used in the field to carry out observations and collect raw data, which is then transmitted to a central data collector. This central data collector creates map data based on the crowd-based collection of raw data, which is made available via service providers for highly automated and/or even autonomous driving.

Specific recommendations to vehicles to behave in a certain way on certain routes can include, for example, recommendations for certain driving speeds, recommendations for certain trajectories that a vehicle should follow in a lane and similar information.

### SUMMARY

Based on this, it is the task of the present disclosure to at least partially solve the problems described with reference to the prior art and, in particular, to propose a method with which a highly automated or possibly even autonomous driving function can implement a particularly natural driving behavior, possibly even particularly similar to that of a human driver.

These tasks are solved with a method according to the features set forth below. Further advantageous embodiments are specified in the description and in particular also in the description of the figures. It should be noted that the skilled person can combine individual features in a technologically meaningful way and thus arrive at further embodiments of the disclosure.

The following describes a method for performing a highly automated driving operation of a vehicle, comprising the following steps of:
A) reading driving behavior recommendation data into the vehicle for at least one route sequence on which the vehicle is planned to travel;
B) performing a highly automated driving operation of the vehicle based on the driving behavior recommendation data read according to step A).

It is particularly advantageous if the driving behavior recommendation data read in step A) has previously been generated in accordance with the following steps:
a) collecting driving behavior data from a plurality of vehicles while they are in operation;
b) defining predefined route sequences (1) for which driving behavior data is to be generated; and
c) generating driving behavior recommendation data for predefined route sequences (1) based on the driving behavior data.

Such driving behavior recommendation data can therefore be collected, for example, as statistical information on the driving behavior of drivers in crowd-based approaches. Data collected in this way can be obtained in particular when human drivers travel certain routes. This is done in step a). The driving behavior of human drivers can be evaluated and based on this driving behavior, driving recommendation data can then be generated for highly automated/autonomous driving functions, which enable the highly automated (possibly autonomous) driving functions to realize a natural, almost human driving behavior. This is done in step c).

The route sequences for which the driving behavior recommendation data is read in in step A) and for which the driving behavior recommendation data is generated according to step c) were preferably determined beforehand using a topological map of the traffic infrastructure. The route sequences preferably always represent sections of road on which a vehicle's driving behavior that is coordinated across the sections of road is advantageous. Route sequences preferably comprise several sections of road between which there are so-called route elements, which can include curves, intersections, forks or roundabouts, for example.

Such route sequences can also be referred to as route combinations. Route elements can also be referred to as route transitions.

The definition of route sequences or routes for which driving behavior recommendation data is created according to step c) can be done manually and/or automatically.

At a fork, for example, drivers drive straight ahead or turn off. It is noticeable and easy to understand that drivers turning off slow down beforehand, while drivers driving straight ahead reduce their speed significantly less. In this case, an initial route sequence could be a section of road before the fork and another section of road after the junction on the straight road. In this case, a second route sequence could be a section of the route before the fork and a section of the route after the fork on the road that branches off. Different driving behavior recommendation data could then be stored for the first route sequence and the second route sequence, enabling the highly automated/autonomous driving function to adapt its driving behavior (in this case the speed of the vehicle) accordingly.

It is particularly preferred if, for the execution of step c), a statistical evaluation is performed of driving behavior data collected in accordance with step a) from vehicles that have completely traveled the predefined route sequences during the acquisition of the respective driving behavior data.

Preferably, such driving behavior data is selected in order to generate the respective driving behavior recommendation data for the respective route sequence.

The predefinition of route sequences according to step b) can also be carried out on the basis of statistical evaluations of the driving behavior data collected according to step a).

Route sequences can also comprise several sections of road and route elements—for example, a sequence of curves that drivers usually negotiate in a coordinated manner.

The approach described here of providing driving behavior recommendation data for route sequences offers a number of advantages. The provision of statistical information on driving behavior for each direction of travel is (as is clear in the case of the example given above with a first route sequence and a second route sequence around a fork) valuable information for a vehicle traveling on or coming from one of the two routes/route sequences. If the sections of road before and after the fork were considered separately, driving behavior data from vehicles driving straight ahead and driving behavior data from vehicles turning off would be mixed together when creating driving behavior recommendation data according to step c). This would not correspond to the natural driving behavior of human drivers.

It is particularly preferred if driving behavior data collected in step a) comprises at least one of the following types of data:
travel speed information;
acceleration information;
trajectory information;
information about the behavior of a driver of the vehicle;
distance information;
time information;
weather information; or
brightness information.

All this data can be recorded and collected during vehicle journeys (especially journeys with human drivers) and used to generate driving behavior recommendation data.

Furthermore, it is preferred if route sequences are defined such that traveling along a route sequence by a vehicle comprises the execution of at least one driving maneuver.

It is also preferable for route sequences to comprise at least one of the following driving maneuvers:
turning;
driving straight ahead despite having the option to turn;
changing lanes;
merging;
stopping; or
accelerating.

It is also preferable for route sequences to run through at least one of the following route elements:
intersection;
fork;
ramp;
exit;
curve; or
roundabout.

Route sequences preferably consist of sections of road between which the described route elements are arranged. Vehicles that pass over the route elements must preferably perform at least one driving maneuver.

The method described here is used to observe driving maneuvers or the driving behavior that vehicles perform based on route elements. This observed behavior is used to generate driving behavior recommendation data. The driving behavior recommendation data is then used for other vehicles and for performing highly automated (possibly autonomous) driving functions of these vehicles on the route sequences.

Route sections are preferably part of different route sequences in the map data. Depending on how many route elements (forks etc.) there are in the vicinity of a section of road, the more route sequences the section of road can occur in. Map data containing the route sequences described here with driving behavior recommendation data can contain a plurality of partially overlapping route sequences. When planning the route for a vehicle with highly automated or even autonomous driving functions, the route sequences that best match the planned route are determined and taken into account, along with the best driving behavior recommendation data.

It is particularly preferred if driving behavior recommendation data contains at least one of the following data for controlling the highly automated driving operation on the respective route sequence:
trajectory information;
travel speed information;
acceleration information; or
distance information.

All these types of data can be beneficial for highly automated or autonomous vehicle operation. Trajectory information can, for example, contain data on where in a lane a vehicle should position itself to follow a certain route sequence. For example, when turning, it may be advisable for a vehicle to position itself closer to the side of the fork. In other situations, it may be advisable (to achieve a larger turning radius) for a vehicle to first move to the side of a lane opposite the fork and only then follow the fork. Such information can be contained as trajectory information or as trajectory recommendations in driving behavior recommendation data.

Driving speed information as driving behavior recommendation data can help to adapt the driving speed of a vehicle sensibly to the respective situation. The same applies to acceleration information.

Distance information can contain information on the distance a vehicle should keep to vehicles in front. Such information can also be collected as driving behavior data and provided in the form of driving behavior recommendation data.

Various other data or information is useful as driving behavior recommendation data.

It is particularly advantageous if the processing of driving behavior recommendation data for the implementation of highly automated driving in step B) is carried out depending on at least one of the following pieces of situational information:
time information;
weather information;
brightness information;
travel speed information; or
acceleration information;
Preferably, pieces of situational information are recorded in step B). Preferably, the driving behavior recommendation data is structured in such a way that different driving behavioral recommendations can be determined from the driving behavior recommendation data depending on the respective pieces of situational information.

### BRIEF DESCRIPTION OF THE DRAWINGS

The disclosure and the technical environment of the disclosure are explained in more detail below on the basis of the figures. The figures show a preferred exemplary embodiment, to which the disclosure is not limited. It should be noted that the figures and the size relationships shown in the figures are merely schematic. The figures show schematically and as an example:

FIG. 1: An example of a situation with two different route sequences in the vicinity of a fork;

FIG. 2: an example of driving behavior recommendation data for the first route sequence shown in FIG. 1; and

FIG. 3: an example of driving behavior recommendation data for the second route sequence shown in FIG. 1.

### DETAILED DESCRIPTION

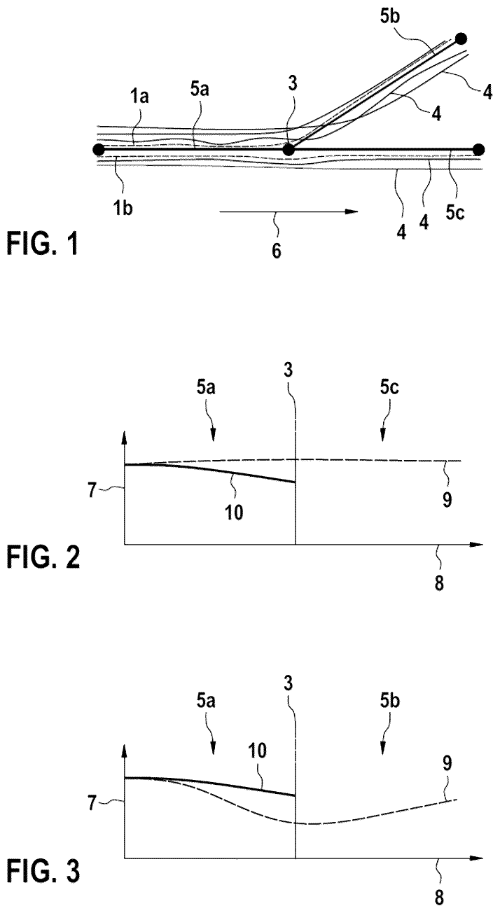

FIG. 1 shows a road situation with a straight ahead lane and a branching lane. The straight-ahead lane is formed by sections 5a and 5c. The branching lane is formed by section 5b and branches off from the straight lane at the fork formed by section 3. The direction of travel 6 is marked by an arrow in FIG. 1. For the method described here, a first route sequence 1a consisting of sections of road 5a and 5b and the fork as route element 3 between them, as well as a second route sequence 1b consisting of sections of road 5a and 5b and the fork as route element 3 between them, are stored in the map data. Trajectories 4 are shown as an example, along which vehicles follow either the first route sequence 1a or the second route sequence 1b. Vehicles that follow the first route sequence 1a have a different driving behavior than vehicles that follow the second route sequence 1b.

The different driving behavior of vehicles following the first route sequence 1a and vehicles following the second route sequence 1b is stored for the route sequence 1a, 1b in driving behavior recommendation data, which is generated in accordance with the method described and can be used for highly automated (possibly autonomous) driving operation.

The different driving behavior of vehicles following the first route sequence 1a and vehicles following the second route sequence 1b as well as the corresponding different driving behavior recommendation data are shown as examples in FIGS. 2 and 3.

FIG. 2 relates to the second route sequence 1b according to FIG. 1 (straight ahead travel) and FIG. 3 relates to the first route sequence 1a according to FIG. 1 (turning). The speed curve 9 is plotted on the speed axis 7 over the distance axis 8. The speed curve 9 as shown in FIG. 2 is essentially constant. The vehicle travels straight ahead along sections of road 5a and 5c, so that it is not necessary to reduce the vehicle speed at the fork (route element 3). The speed curve 9 as shown in FIG. 3 is reduced by the vehicle on section of road 5a in order to drive through the fork (route element 3) at reduced speed and then accelerate again on section of road 5b. The speed curves 9 according to FIGS. 2 and 3 can be driving behavior recommendation data, which are generated according to step c), read according to step A) and used according to step B) for the highly automated (possibly autonomous) driving function.

This driving behavior recommendation data can, for example, be generated using statistical methods from driving behavior data collected in step a). To illustrate why the distinction between a first route sequence 1a and a second route sequence 1b is very advantageous, FIGS. 2 and 3 each show a comparative speed curve 10 for the section of road 5a for comparison. If the evaluation of driving behavior data does not distinguish between the first route sequence 1a and the second route sequence 1b, but instead evaluates driving behavior data from vehicles that follow these two different route sequences in a mixed manner, this comparative speed curve 10 is obtained, which does not accurately reflect either the driving behavior along the first route sequence 1a or the driving behavior along the second route sequence 1b. This can be prevented by considering route sequences consisting of several sections of road in accordance with the procedure described here.

What is claimed is:

1. A method for performing a highly automated driving operation of a vehicle, comprising:
A) reading driving behavior recommendation data into the vehicle for at least one route sequence on which the vehicle is planned to travel; and
B) performing a highly automated driving operation of the vehicle based on the driving behavior recommendation data read according to step A).

2. The method according to claim 1, wherein the driving behavior recommendation data read in step A) was previously generated according to the following steps:
a) collecting driving behavior data from a plurality of vehicles while they are in operation;
b) defining predefined route sequences for which driving behavior data is to be generated; and
c) generating driving behavior recommendation data for predefined route sequences based on the driving behavior data.

3. The method according to claim 2, wherein:
for the execution of step c), a statistical evaluation is performed of driving behavior data collected in step a) from vehicles which have completely traveled the predefined route sequences during the acquisition of the respective driving behavior data.

4. The method according to claim 2, wherein the driving behavior data collected in step a) comprise at least one of the following data types:
travel speed information;
acceleration information;
trajectory information;
information about the behavior of a driver of the vehicle;
distance information;
time information;
weather information; or
brightness information.

5. The method according to claim 1, wherein route sequences are defined such that traveling along a route sequence by a vehicle comprises performing at least one driving maneuver.

6. The method according to claim 1, wherein route sequences comprise at least one of the following driving maneuvers:
turning;
driving straight ahead despite having the option to turn;
changing lanes;
merging;
stopping; or
accelerating.

7. The method according to claim 1, wherein route sequences pass through at least one of the following route elements:
intersection;
fork;
ramp;
exit;
curve; or
roundabout.

8. The method according to claim 1, wherein driving behavior recommendation data includes at least one of the following data for controlling the highly automated driving operation on the respective route sequence:
trajectory information;
travel speed information;
acceleration information; or
distance information.

9. The method according to claim 1, wherein the processing of driving behavior recommendation data for performing the highly automated driving operation in step B) is carried out depending on at least one of the following pieces of situational information:
time information;
weather information;
brightness information;
travel speed information; or
acceleration information.
